(19) United States
(12) Patent Application Publication
(10) Pub. No.: US 2018/0207999 A1
(43) Pub. Date: Jul. 26, 2018

(54) CENTRAL TYRE INFLATION SYSTEM

(71) Applicant: JAGUAR LAND ROVER LIMITED, Whitley , Coventry, Warwickshire (GB)

(72) Inventors: Emma-Claire DUNNING, Coventry, West Midlands (GB); Paul KING, Loughborough, Leicestershire (GB); Robbie LESBIREL, Leamington Spa, Warwickshire (GB); Maelle DODU, Leamington Spa, Warwickshire (GB); Thuy-Yung TRAN, Rugby, Warwickshire (GB)

(21) Appl. No.: 15/745,677

(22) PCT Filed: Jul. 14, 2016
(86) PCT No.: PCT/EP2016/066762

§ 371 Date: Jan. 17, 2018

(30) Foreign Application Priority Data
Jul. 17, 2015 (GB) 1512498.5

(51) Int. Cl. B60C 23/00

(52) U.S. Cl. CPC B60C 23/003

(57) ABSTRACT

A central tire inflation system (CTIS) of a vehicle (VH) for supplying compressed air to a tire of the vehicle to compensate for air loss from the tire. The CTIS determines a rate of air loss from the tire and includes both a sensor arranged to measure a temperature of a compressor of the CTIS and an electronic control unit (ECU) configured to: compare the rate of air loss with a rate of air loss threshold, determine, based on the compressor temperature and the comparison of the rate of air loss with the rate of air loss threshold, whether the CTIS can support compensation for the air loss; and control the CTIS to supply compressed air to the tire to compensate for the air loss if the CTIS can support compensation for the air loss.

### TECHNICAL FIELD

The present invention relates to a central tyre inflation system (CTIS) for inflating a tyre of a vehicle to compensate for a puncture or similar air loss; to an engine control unit (ECU); to a method; to a vehicle; and to a computer program product.

### BACKGROUND

Heavy goods, military and off-road vehicles are sometimes equipped with a central tyre inflation system (CTIS) which can inflate or deflate each tyre of the vehicle to a desired pressure. Such systems are also used to detect air leakages from tyres, and to compensate for any air loss. This can maintain the integrity of a tyre over long periods in the event of a minor puncture, and can provide additional time for the driver to react appropriately if the puncture is more severe. A CTIS often operates in combination with a tyre pressure monitoring system (TPMS) which provides measurements of air pressure in each of the tyres of a vehicle.

Central tyre inflation systems have thus far been installed mainly in large non-consumer vehicles that can easily accommodate the CTIS components. Noise such as may be generated, for example, by a compressor of the system during tyre inflation, is typically of little concern in such vehicles, which often have many sources of noise including a relatively large engine.

However, to implement a CTIS in a consumer vehicle is more challenging as space is much more limited and a higher level of refinement is required. In particular, the noise generated by the CTIS compressor during tyre inflation is much more noticeable in a consumer vehicle and may be considered unacceptable. While it is possible to enclose the compressor in a noise-reducing housing, this may create other problems such as overheating of the compressor due to the restrictive effect that such a housing has on heat dissipation.

It is against this background that the present invention has been devised.

### SUMMARY OF THE INVENTION

Aspects and embodiments of the invention provide a CTIS for inflating a tyre of a vehicle to compensate for a puncture or similar air loss; an ECU; a vehicle; a method; and a computer program product as claimed in the appended claims.

According to an aspect of the present invention there is provided a CTIS of a vehicle for supplying compressed air to a tyre of the vehicle to compensate for air loss from the tyre. The CTIS comprises means for determining a rate of air loss from the tyre, a sensor arranged to measure a temperature of a compressor of the CTIS, and an electronic control unit (ECU). The ECU is configured to compare the rate of air loss with a rate of air loss threshold, and to determine, based on the compressor temperature and the comparison of the rate of air loss with the rate of air loss threshold, whether to use the CTIS to compensate for the air loss. The ECU is further configured to control the CTIS to supply compressed air to the tyre to compensate for the air loss if it is determined to use the CTIS to compensate for the air loss.

The air loss can be through the tyre directly, i.e. a small puncture, and/or from a CTIS or tyre component, e.g. an air leakage through a damaged CTIS valve or tyre inflation valve that results in a pressure loss from the tyre. By compensating for air loss from the tyre, the vehicle can continue to operate without adversely affecting the integrity of the tyre.

The means for determining a rate of air loss from the tyre may comprise one or more pressure sensors and/or flow sensors, and circuitry configured to receive signals from the pressure sensors and/or flow sensors and to identify a drop in pressure or a non-zero air flow from the tyre, as appropriate, to determine a rate of air loss from the tyre.

In one example, the means for determining a rate of air loss from the tyre comprises a valve that is operable by the ECU to open or close communication between the tyre and a supply line through which compressed air is supplied to the tyre, and a pressure sensor configured to measure air pressure in the supply line. In such embodiments, the ECU is arranged to open the valve, to take a first measurement of air pressure in the supply line while the valve is open, and then close the valve. Then, after a time interval has elapsed the ECU re-opens the valve and, while the valve is open, takes a second measurement of air pressure in the supply line. Finally, the ECU compares the first and second measurements of air pressure to determine the rate of air loss.

The ECU may be configured to calculate the rate of air loss threshold with reference to a pumping capacity of the compressor of the CTIS. For example, the air loss threshold may be calculated on the basis of a leakage rate that the CTIS is capable of supporting over a predetermined time period without reference to the compressor temperature.

The ECU may be configured to determine, based on the compressor temperature, whether the compressor can operate for a defined period without exceeding a temperature threshold. In this case, the ECU is further configured to determine that the CTIS cannot support compensation for the air loss if the compressor temperature will exceed the temperature threshold in the defined period. The defined period may be defined in terms of a fixed time period, or alternatively as a distance of vehicle travel, in which case the instantaneous vehicle speed is used to calculate the defined period.

The ECU may be configured to calculate the rate of air loss threshold with reference to the compressor temperature. Optionally both the compressor temperature and the pumping capacity of the compressor are used in calculating the rate of air loss threshold, meaning that the threshold represents an air loss rate that the CTIS can compensate for without overheating.

The CTIS may comprise an input arranged to receive a signal indicative of air pressure within the tyre. In such embodiments the ECU is configured to monitor the signal indicative of air pressure within the tyre to detect a leak from the tyre prior to determining a rate of air loss from the tyre. The signal indicative of air pressure within the tyre may be received from a TPMS installed on the vehicle.

Alternatively, the CTIS may comprise an input arranged to receive from the TPMS a signal indicative of a leak from the tyre, dispensing with the need for the CTIS to identify a leak, for example from monitoring pressure measurements.

The ECU may be configured to control the CTIS to inflate the tyre at least substantially to a target tyre pressure. The ECU may also be configured to generate an output signal to inform a user of the vehicle that the CTIS will not attempt to inflate the tyre if the CTIS cannot support compensation for the air loss. The ECU is optionally configured to determine a vehicle speed limit based on the rate of air loss from the tyre.

Compensating for the air loss optionally comprises controlling the CTIS to supply compressed air to the tyre at a rate which is substantially equal to or greater than the determined rate of air loss from the tyre.

The invention also extends to a vehicle comprising a CTIS of the above aspect.

Another aspect of the invention provides a method of controlling operation of a CTIS of a vehicle to supply compressed air to a tyre of the vehicle to compensate for air loss from the tyre. The method comprises determining a rate of air loss from the tyre, measuring a temperature of a compressor of the CTIS, comparing the rate of air loss with a rate of air loss threshold, and determining, based on the compressor temperature and the comparison of the rate of air loss with the rate of air loss threshold, whether to use the CTIS to compensate for the air loss. The method further comprises using the CTIS to supply compressed air to the tyre to compensate for the air loss if it is determined to use the CTIS to compensate for the air loss.

The method may comprise calculating the rate of air loss threshold with reference to a pumping capacity of the compressor of the CTIS, with reference to the compressor temperature, or both.

The method may comprise determining based on the compressor temperature whether the compressor can operate for a defined period without exceeding a temperature threshold, and determining that the CTIS cannot support compensation for the air loss if the compressor temperature will exceed the temperature threshold in the defined period.

The method may comprise detecting a leak from the tyre prior to determining a rate of air loss from the tyre. Detecting a leak from the tyre may comprise monitoring a signal indicative of air pressure within the tyre, which signal may be obtained from a TPMS installed on the vehicle. The method may further comprise outputting a notification signal indicative of a drop in tyre pressure if the signal indicative of air pressure within the tyre indicates that the tyre pressure is below a tyre pressure threshold. Alternatively, detecting a leak from the tyre may comprise receiving a signal indicative of a leak from the TPMS.

The rate of air loss from the tyre may be determined using the CTIS. For example, the CTIS may comprise a valve that is operable to open or close communication between the tyre and a supply line through which compressed air is supplied to the tyre, in which case the method comprises: opening the valve; while the valve is open, taking a first measurement of air pressure in the supply line; closing the valve; re-opening the valve after a time interval has elapsed; while the valve is open, taking a second measurement of air pressure in the supply line; and comparing the first and second measurements of air pressure to determine the rate of air loss.

Determining the rate of air loss may comprise taking at least two measurements of air pressure within the tyre at different times. Taking a measurement of the air pressure within the tyre may comprise opening a valve of the CTIS. In such embodiments, the method may comprise controlling the CTIS to inflate the tyre prior to taking measurements of air pressure within the tyre.

The invention also extends to an ECU for controlling a CTIS, the ECU being configured to implement the method of the above aspect.

Another aspect of the invention provides a computer program product comprising a computer readable storage medium including computer readable program code. The computer readable program code when executed causes a processor to implement the method of the above aspect.

For the avoidance of doubt, references herein to a central tyre inflation system (CTIS) are to an apparatus for controlling the pressure of one or more tyres.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

For the purposes of this disclosure, it is to be understood that the control system described herein can comprise a control unit or computational device having one or more electronic processors. A vehicle and/or a system thereof may comprise a single control unit or electronic controller or alternatively different functions of the controller(s) may be embodied in, or hosted in, different control units or controllers. As used herein, the term “control unit” will be understood to include both a single control unit or controller and a plurality of control units or controllers collectively operating to provide the required control functionality. The term “module” is likewise intended to include either a single computational module performing a single or multiple functions or a plurality of computational modules performing separable functions. A set of instructions could be provided which, when executed, cause said controller(s) or control unit(s) or module(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

### BRIEF DESCRIPTION OF DRAWINGS

One or more embodiments of the present invention will now be described, by way of example only, with reference to the accompanying drawings, in which like components are assigned like numerals, and in which:

FIG. 1 is a schematic representation of a central tyre inflation system (CTIS) according to an embodiment of the invention;

FIG. 2 is a schematic representation of a valve arrangement of the CTIS shown in FIG. 1;

FIG. 3 is a vehicle system boundary diagram representing the CTIS shown in FIGS. 1 and 2;

FIG. 4 is a flow diagram showing a process according to an embodiment of the invention for controlling the CTIS of FIGS. 1 to 3; and

FIG. 5 is a flow diagram showing a process according to another embodiment of the invention for controlling the CTIS of FIGS. 1 to 3.

### DETAILED DESCRIPTION

In the following description and in the drawings, reference letters are used to collectively or un-specifically identify equivalent or essentially equivalent components. Where necessary, a specific component in a collection of equivalent or essentially equivalent components is identified by suffixing a reference letters in subscript format.

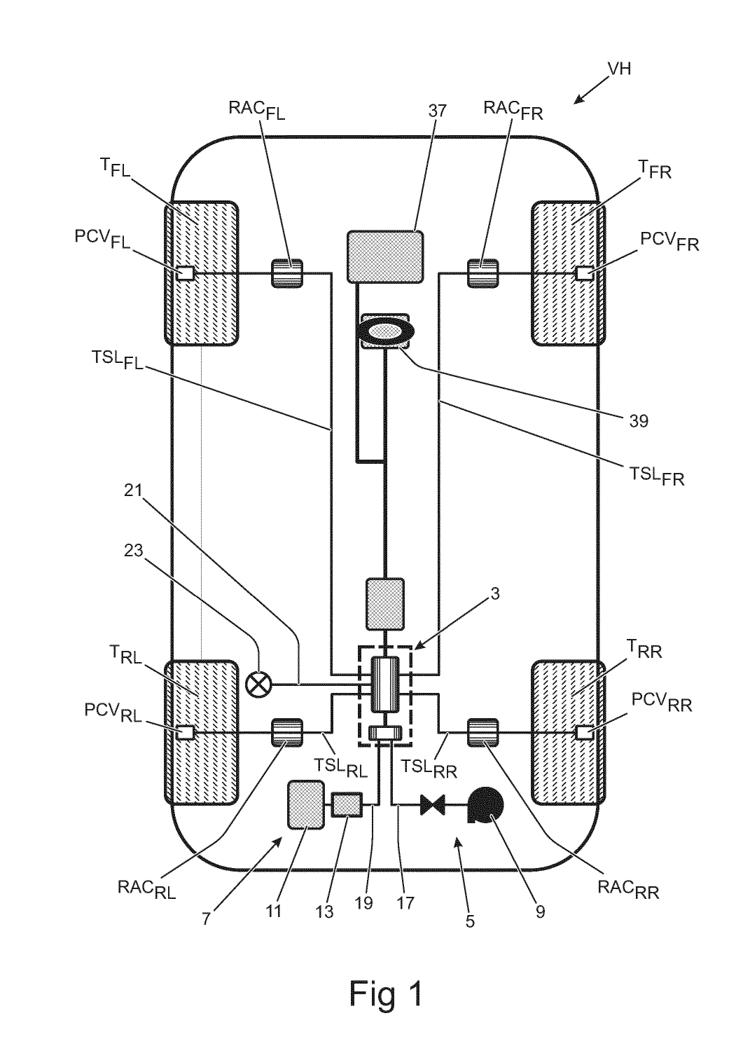

To provide context for the invention, FIG. 1 shows schematically a CTIS 1 that is suitable for use in embodiments of the invention, although it should be appreciated that the CTIS 1 described here is merely representative of the type of system that may be used, and many other variations are possible.

The CTIS 1 is installed in a vehicle VH that has four wheels W each having a tyre T mounted on a wheel hub (not shown). The wheels W (and the tyres T) are identified herein based on their relative position on the vehicle VH, namely: front left (FL), front right (FR), rear left (RL) and rear right (RR). This nomenclature is employed to identify the components of the CTIS 1 associated with the respective tyres T. The front tyres T_{FR}, T_{FL} are mounted on a front axle and the rear wheels T_{RR}, T_{RL} are mounted on a rear axle of the vehicle.

The CTIS 1 comprises four pneumatic control valves PCV fixedly mounted to the wheel hubs and arranged to control the supply of compressed air to and from a respective tyre cavity. The pneumatic control valves PCV are pneumatically operated in response to changes in the pressure in the associated tyre supply line TSL. Specifically, the pneumatic control valves PCV are operable to cycle sequentially (i.e. to toggle) between an open state and a closed state in response to the application of a pressure exceeding a valve activation pressure. The pneumatic control valves PCV are stable in both the open and closed state via a latching mechanism, i.e. they can each be considered as a pressure actuated bi-stable valve. Herein the application of air at a pressure and time sufficient to switch the valve from one state to its other state, i.e. from open to closed or from closed to open, is referred to as “toggling” the valve, and the application of said air in this manner is referred to as a high pressure (pneumatic) control signal.

UK Patent application GB2516704 describes such a pneumatic latching valve suitable for a CTIS system. It will be appreciated that each pneumatic control valve could have additional operating states which are cycled through sequentially in dependence on said pneumatic control signal.

The CTIS 1 further comprises a valve block 3 for controlling the supply of compressed air to each of the pneumatic control valves PCV. The valve block 3 is fluidly coupled to a first compressed air source 5 and a second compressed air source 7. The first compressed air source 5 provides air at a high flow rate and low pressure (HF/LP); and the second compressed air source 7 is operable to provide air at a higher pressure. In the present arrangement, the first compressed air source 5 comprises a compressor 9; and the second compressed air source 7 comprises a reservoir 11 having an associated reservoir pressure sensor 13. The compressor 9 can be used to supply the reservoir 11 with compressed air to increase the pressure therein.

The activation pressure of each said pneumatic control valve PCV is below the pressure of the second compressed air source 7. In this manner the second compressed air source 7 can be applied for a short duration to switch one or more selected pneumatic control valves PCV from a closed state to an open state, and vice versa.

An electronic control unit (ECU) 15 is provided to control operation of the CTIS 1. Specifically, the ECU 15 is configured to control operation of the valve block 3 and the compressor 9.

A tyre supply line TSL supplies compressed air from the valve block 3 to each tyre T. Specifically, the CTIS 1 comprises a front left tyre supply line TSL_{FL}, a front right tyre supply line TSL_{FR}, a rear left tyre supply line TSL_{RL} and a rear right tyre supply line TSL_{RR}. The pneumatic control valves PCV are provided at the ends of the tyre supply lines TSL to control the supply of compressed air to the respective tyres T. A section of each tyre supply line TSL extends along the respective vehicle axles to supply compressed air to the pneumatic control valves PCV mounted in each wheel hub. A rotary air coupling (RAC) is provided in each tyre supply line TSL to provide a fluid coupling to supply compressed air from the valve block 3 to the section of each tyre supply line TSL disposed in the vehicle axle.

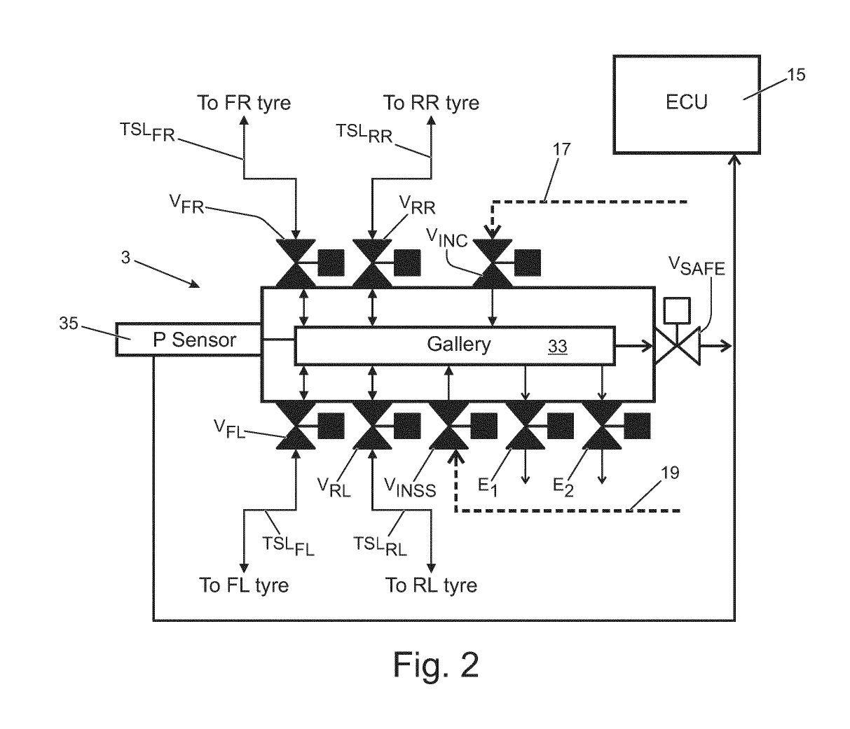

The valve block 3 will now be described in more detail with reference to FIG. 2. The valve block 3 comprises first and second inlet valves V_{INC}, V_{INSS}. The first inlet valve V_{INC} operatively controls the supply of compressed air from the first compressed air source 5 which is connected to the valve block 3 by a first supply line 17. The second inlet valve V_{INSS} operatively controls the supply of compressed air from the second compressed air source 7 which is connected to the valve block 3 by a second supply line 19.

The valve block 3 comprises four outlet valves (collectively referenced as V_{O}) for controlling the supply of compressed air to the respective tyre supply lines TSL. In particular, the valve block 3 comprises: a front left outlet valve V_{FLO} for controlling the supply of compressed air to the front left tyre supply line TSL_{FL}; a rear left outlet valve V_{RLO} for controlling the supply of compressed air to the rear left tyre supply line TSL_{RL}; a front right outlet valve V_{FRO} for controlling the supply of compressed air to the front right tyre supply line TSL_{FR}; and a rear right outlet valve V_{RRO} for controlling the supply of compressed air to the rear right air supply line TSL_{RR}. The outlet valves V_{O} are operable independently of each other to enable the selective supply of compressed air to one or more of the tyre supply lines TSL.

The valve block 3 also comprises first and second exhaust valves E₁, E₂ coupled to an exhaust line 21. The exhaust line 21 terminates with an exhaust outlet 23 which is open to atmosphere to vent exhaust air from the CTIS 1. The first and second exhaust valves E₁, E₂ are operable to control the flow of exhaust air to the exhaust line 21, for example during tyre deflation. A safety valve V_{SAFE} is also provided in the valve block 3. The safety valve V_{SAFE} is operable to vent to atmosphere any excess air which might accumulate in the valve block 3 due, for example, to malfunction of any of the components of the CTIS 1.

The inlet valves V_{INC}, V_{INSS}, the outlet valves V_{O} and the exhaust valves E₁, E₂ are solenoid valves having a normally-closed configuration (illustrated by a filled symbol in FIG. 2). The inlet valves V_{INC}, V_{INSS}, the outlet valves V_{O} and the exhaust valves E₁, E₂ are operable independently of each other and are actuated by control signals received from the ECU 15. The safety valve V_{SAFE} is also a solenoid valve but has a normally-open configuration (illustrated by an open symbol in FIG. 2). The safety valve V_{SAFE} is closed by receiving a control signal from the ECU 15.

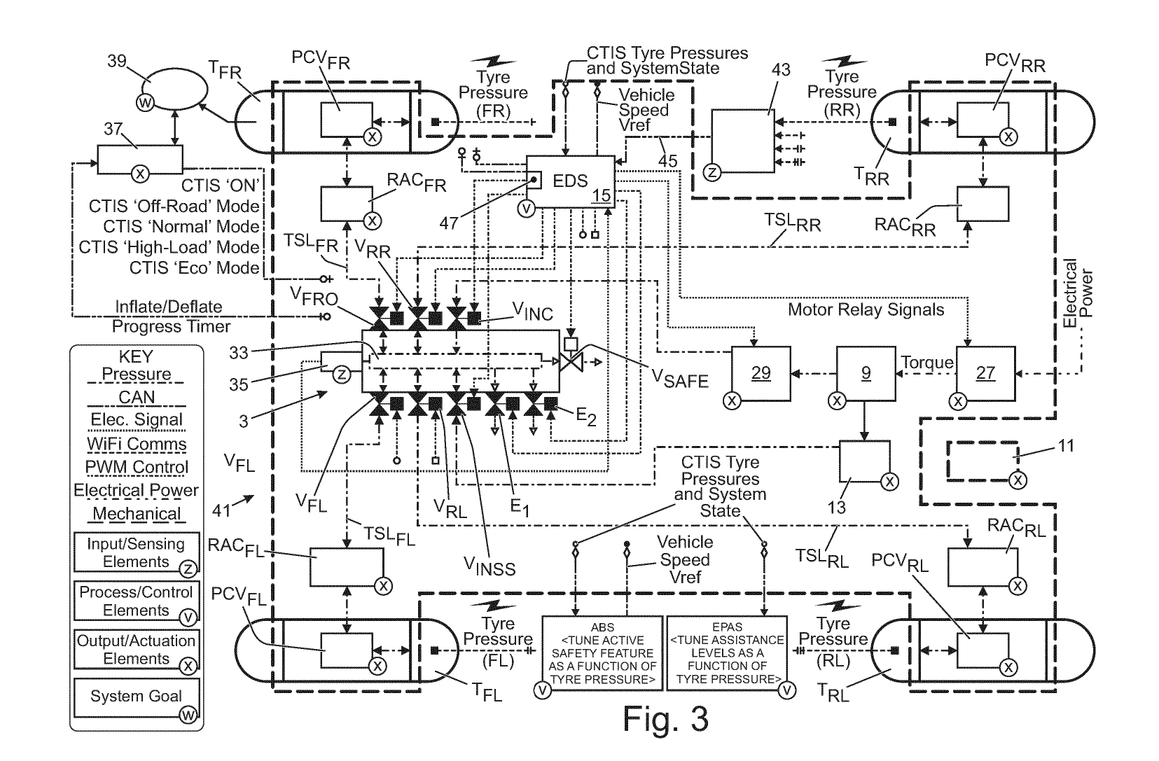

The compressor 9 is a dedicated compressor for the CTIS 1. The compressor 9, and air outlet from the reservoir 11 are controlled, directly or indirectly, by the ECU 15. The compressor 9 comprises an electric motor 27 (shown in FIG. 3) and has an operating pressure of up to approximately 9 bar. A dryer unit 29 (shown in FIG. 3) is coupled to the compressor 9 partway through a first compressed air supply line 31 (shown in FIG. 3) connecting the compressor 9 to the valve block 3. Compressed air at a pressure of up to 9 bar is stored in the reservoir 11.

A fluid gallery 33 is provided in the valve block 3. The gallery 33 is open to each of: the outlet valves V_{O}, the inlet valves V_{INC}, V_{INSS}, the exhaust valves E₁, E₂, and the safety valve V_{SAFE}. The valve block 3 houses a pressure sensor 35 arranged to measure the pressure in a gallery 33. The gallery 33 can be selectively placed in fluid communication with one or more of the tyre supply lines TSL by opening one or more of the outlet valves VO. In the present arrangement, the pressure sensor 35 measures the pressure in the individual tyre supply lines TSL by placing the tyre supply line TSL in fluid communication with the gallery 33. By opening the pneumatic control valve PCV associated with that tyre supply line TSL, the pressure sensor 35 can measure the air pressure in the tyre cavity (hereinafter referred to, for simplicity, as the tyre pressure).

The gallery 33 receives compressed air from each of said first and second compressed air sources 5, 7 via the respective first and second inlet valves V_{INC}, V_{INSS}. The first inlet valve V_{INC} is operable to control the supply of compressed air from the first compressed air source 5 to the gallery 33. The second inlet valve V_{INSS} is operable to control the supply of compressed air from the second compressed air source 7 to the gallery 33. In use, the first compressed air source 5 is the primary source of compressed air for inflating the tyres T. One or more of the tyre supply lines TSL can be placed in communication with the first compressed air source 5 by opening the first inlet valve V_{INC} and the appropriate outlet valves V_{O}. The second compressed air source 7 provides a higher pressure supply which is controlled by the second inlet valve V_{INSS} to generate a pneumatic control signal as described above for controlling operation of one or more of said pneumatic control valves PCV to tyres for which the respective outlet valves V_{O} are open, i.e. to toggle the valves from one stable state to the other stable state. Specifically, the second inlet valve V_{INSS} is operated to generate the pneumatic control signal to cycle the pneumatic control valve(s) PCV in communication with the gallery 33. The pneumatic control valve(s) PCV cycle through their respective operating states in response to the pneumatic control signal and, therefore, can be operated to control the supply of compressed air to and from the respective tyres T. By opening the pneumatic control valve(s) PCV, one or more of the tyres T can be placed in communication with the respective tyre supply lines TSL. The valve block 3 can be operated to place the tyre supply lines TSL in communication with the first compressed air source 5 to inflate one or more of said tyres T; or in communication with the exhaust line 21 to deflate one or more of said tyres T. Furthermore, the valve block 3 can be operated to measure the pressure of the air in the tyres T.

To measure an individual tyre pressure of a wheel having a closed PCV, the valve block 3 is operated to close the first and second inlet valves V_{INC}, V_{INSS}, and the exhaust valves E₁, E₂. The outlet valve V_{O} corresponding to the tyre supply line TSL for the particular tyre is opened to place the tyre supply line TSL in fluid communication with the gallery 33. A pneumatic control signal is then generated by operating the second inlet valve V_{INSS} to open the pneumatic control valve PCV for that tyre T. The tyre T is thereby placed in communication with the gallery 33 via the corresponding tyre supply line TSL. The pressure sensor 35 then measures the air pressure in the gallery 33 to determine the tyre pressure for that particular tyre T. Once the pressure has been measured, if no further action is required in relation to that tyre a pneumatic control signal may be generated by operating the second inlet valve V_{INSS} to close the pneumatic control valve PCV.

The CTIS 1 according to the present arrangement uses a single pressure sensor 35 for measuring the pressure in the gallery 33. It will be appreciated that more than one pressure sensor 35 could be provided. For example, a pressure sensor 35 could be provided in communication with each tyre supply line TSL. Equally, a separate valve block 3 could be provided for each tyre T or for each axle.

The ECU 15 is programmed to control the overall operation of the CTIS 1. The ECU 15 is configured to determine an inflation time or a deflation time. The inflation time is the period of time over which compressed air must be supplied from the first compressed air source 5 to the one or more tyre(s) T to reach the target tyre pressure. The inflation time is a function of one or more of the following: the pressure differential between the target tyre pressure and the current tyre pressure (the current tyre pressure being the tyre pressure prior to inflation); the operating characteristics of the first compressed air source (e.g. nominal pressure and flow rate); the number of tyres T which are being inflated at any given time (if more than one tyre T can be inflated simultaneously); and the volume and/or temperature of the tyre cavities.

The deflation time is the period of time over which compressed air must be vented from the one or more tyre(s) T through the first and second exhaust valves E₁, E₂ to reach the target tyre pressure. The deflation time is also a function of the number of tyres T being simultaneously deflated, of the current tyre pressure (i.e. the tyre pressure before deflation), of the target tyre pressure and/or the pressure differential to be achieved by tyre deflation and/or of the volume and/or temperature of the tyre cavities.

In the present arrangement, the ECU 15 retrieves the inflation time and/or the deflation time from a look-up table stored in a memory device accessible to the ECU 15. The look-up table can take the form of a double entry table indexed according to the current tyre pressure and the target tyre pressure. Based on the current tyre pressure and the target tyre pressure, the ECU 15 can retrieve from the look-up table a value corresponding to, or representative of, the predetermined tyre inflation time for a given flow rate and air supply air pressure. Alternatively the look-up table may give a volume of air required and the ECU calculates the inflation time based on measured or estimated pressures and flow rates and the retrieved volumetric air requirement. Other methods may be useful.

The ECU 15 controls tyre inflation and/or deflation by opening and closing, as appropriate, the various valves V_{O}, V_{INC}, V_{INSS}, E₁, E₂ of the valve block 3. Tyre inflation and deflation can thus potentially be performed one tyre T at a time, or according to any combination of tyres T simultaneously. In the present arrangement, however, the ECU 15 is programmed to simultaneously deflate all the tyres T, or in pairs, and to inflate the tyres T one at a time or, simultaneously in pairs. If deflated/inflated in pairs, the pairs of tyres T are selected according to their location at the front or rear of the vehicle VH. In this event, the tyres T are said to be deflated/inflated by the CTIS 1 ‘per axle’.

In the present arrangement, the ECU 15 uses an algorithm to refer the current and target tyre pressures to a nominal tyre temperature of 25° C. and to the case of tyre inflation of an individual tyre T. Alternatively, different look-up tables each corresponding to a tyre temperature and/or to the case of tyre inflation for two or more tyres T could be used. Compressed air losses in the CTIS 1 may affect the period of time taken for the CTIS 1 to achieve a predetermined pressure. The values stored in the look-up table could be dynamically updated to take into account the effects of said losses. The values could, for example, be updated via one or more self-learning algorithms.

The ECU 15 is in addition configured to provide information relating to the status and/or operation of the CTIS 1 to a vehicle user via a human-machine interface (HMI) 37. A dashboard (not shown) of the vehicle VH is in addition equipped with a visual output, for example a tyre operation dial 39, to provide a user with information as to whether compressed air is being supplied to, or exhausted from, the tyre cavities.

FIG. 3 illustrates the relationship between the main mechanical components of the CTIS 1 described herein (which incorporates the valve block 3 illustrated in FIG. 2) and a vehicle control system 41. The vehicle control system 41 comprises the ECU 15. The ECU 15 is programmed to implement the control strategies and procedures described herein. In this arrangement, the ECU 15 includes an input which receives from a tyre pressure monitoring system (TPMS) 43, via a vehicle controller area network (CAN) 45, real-time information relating to the current tyre pressures for the four tyres T of the vehicle VH. This real-time information can therefore comprise a signal indicative of tyre pressure in any of the tyres (T), and/or a signal indicative of a leak from a tyre (T).

The pressure sensor communicates directly with the ECU 15 via electric signals representative of the pressure measured by the pressure sensor 35 in the gallery 33 of the valve block 3. As described earlier, the pneumatic control valves PCV and the various valves V, I, E of the valve block 3 can be configured such that the pressure sensor 35 measures a pressure which is representative of the pressure inside each of the tyres T. The TPMS 43 also monitors the temperature inside the tyres T so that the tyre pressures can be referred to a nominal temperature of 25 degrees C. using appropriate algorithms, for example a thermocouple or other thermal sensor may be located in or through the hub of each wheel.

The ECU 15 implements tyre inflation and/or deflation strategies as described herein on the basis of the relationship between the target tyre pressures and the current tyre pressures as measured by the TPMS 43 and/or pressure sensor 35. To do this, the ECU 15 is required to control the various mechanical components of the CTIS 1. As seen in FIG. 3, the ECU 15 is configured to control the outlet valves VO via a pulse width modulation (PWM) control network 47. Via the same PWM control network 47, the ECU 15 also controls the purging function of the dryer unit 29, the electric motor 27 which drives the compressor 9, the first and second inlet valves V_{INC}, V_{INSS}, the exhaust valves E₁, E₂ and the safety valve V_{SAFE}. As described herein, the target tyre pressures can be manually selected by the driver of the vehicle via the human-to-machine interface (HMI) 37 or they can be automatically selected by the vehicle control system 41 on the basis of other information including vehicle driving modes. The HMI 37 communicates with the ECU 15 via the vehicle CAN 45. As an alternative to PWM control full cycle on/off solenoid valves could be used.

As already noted, the above described CTIS 1 enables implementation of inflation and deflation strategies for the tyres T of the vehicle VH during normal operation. In accordance with embodiments of the invention, the CTIS 1 can also be used to detect and mitigate air leakages from the tyres T.

As checking the tyre pressure for a tyre T of the vehicle VH using the CTIS 1 involves opening the respective PCV for that tyre T, which inherently deflates the tyre T to some extent, it is undesirable to check the tyre pressure in this way too frequently. Instead, during normal operation when the CTIS 1 is not actively controlling the tyre pressures and all PCVs are closed, tyre pressure measurements are provided at regular intervals by the TPMS 43. These measurements can be monitored to check for decreasing pressure which may be indicative of air loss from the tyre T, to provide an early indication of leakage. This monitoring can be performed by the TPMS 43 itself, or by a controller such as the ECU 15.

Once a possible leakage has been detected using the TPMS 43 measurements, the CTIS 1 can be used to take more accurate measurements to confirm the presence of a leakage, and to take corrective action as required to compensate for any air loss.

Before attempting to compensate for the air loss, the CTIS 1 is also controlled so as to assess the severity of the leakage and the required work from the compressor 9 to provide compensation. This information can be used, in combination with data relating to other operating conditions such as ambient temperature and the temperature of the compressor 9, to determine whether the compressor 9 is able to provide the required compensation. If the air loss rate is higher than the rate at which the compressor 9 can deliver compressed air to the tyre T, the CTIS 1 will not be able to compensate for the air loss. Even if the air loss rate is lower than the delivery rate, the compressor 9 may still be incapable of providing compensation. This is because if the difference between the air loss rate and the delivery rate is small, it will take a long time for the compressor 9 to compensate the air loss, during which time the compressor 9 may overheat.

It is recalled at this stage that overheating of the compressor 9 may be a problem in consumer vehicles in particular, in which the compressor 9 is likely to be situated within a noise-reducing enclosure that inherently compromises the ability of the compressor 9 to dissipate heat by convection. It is therefore advantageous to be able to assess a leakage to determine whether the compressor 9 will be able to provide compensation without overheating. This enables an appropriate notification to be delivered to the driver via the HMI 37 at an early stage, allowing the driver to take action before the tyre pressure becomes unacceptably low. Otherwise, the system may waste time attempting to inflate a tyre that it is ultimately unable to inflate.

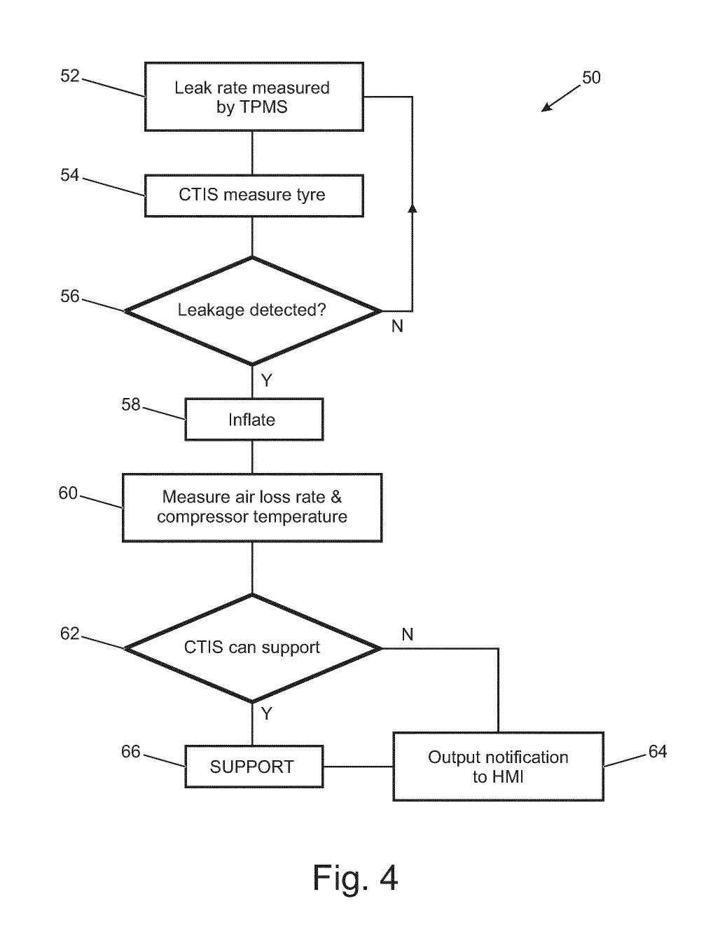

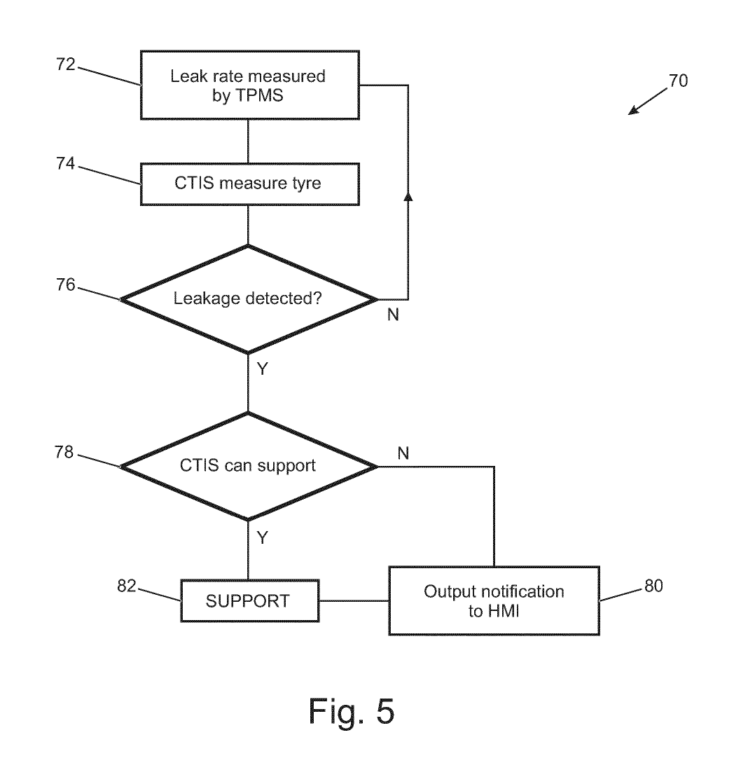

FIGS. 4 and 5 show two alternative ways in which the detection, assessment and compensation of a leakage may be implemented using the above CTIS 1 under the control of the ECU 15. These alternatives shall be described now in turn.

FIG. 4 shows a first process 50 for controlling operation of the CTIS 1 to inflate a tyre T to compensate for air loss. The process 50 begins with a leakage being detected at step 52 by the TPMS 43. This may entail a leakage alert being generated by the TPMS 43 and passed to the CTIS 1, or alternatively pressure measurements output by the TPMS 43 may be monitored by the ECU 15 for leakage detection.

Once a leakage has been detected based on TPMS 43 measurements, the CTIS 1 opens the PCV of the tyre T that is suspected of leaking to take a measurement at step 54 of the tyre pressure. This step is performed as the CTIS 1 is able to capture more accurate data than the TPMS 43. One or more further tyre pressure measurements are taken at spaced intervals, and if the tyre pressure drops between successive measurements a leakage is determined at step 56 to be present. If the CTIS 1 finds no leakage, the TPMS 43 measurement is assumed to be incorrect, i.e. there is a TPMS sensor fault. The process thereafter ignores the TPMS signal and may issue a warning to the driver of a TPMS sensor failure. Alternatively the next time that the vehicle is turned off and turned on again the system may resume normal operation for that cycle of operation, i.e. until the next key off event.

If the CTIS 1 detects that the tyre T is leaking, the CTIS 1 is then controlled to assess the leakage by taking a series of pressure measurements over an extended period of, for example a time period of 1 to 15 minutes (other time periods may be useful), to determine the rate of air loss from the tyre T. The way in which this assessment step is implemented is where the two processes shown in FIGS. 4 and 5 diverge, as shall become clear in the description that follows.

In the process 50 shown in FIG. 4, the tyre T is inflated at step 58 prior to assessing the air loss rate. The extent of the inflation may, for example, be tailored to balance air loss from the tyre T as a result of opening its PCV for each pressure measurement taken by the CTIS 1. Once inflated, the CTIS 1 takes a series of pressure measurements at step 60 over an extended time period as noted above. The temperature of the compressor 9 is also measured. The pressure measurements are analysed to determine the air loss rate. Separately, a rate of air loss threshold is calculated based on the pumping capacity of the compressor 9, taking into account also the compressor temperature measurement, along with other data relating to operating conditions if available. The rate of air loss threshold represents the maximum air loss rate that the compressor 9 can compensate for without overheating. The ECU 15 then determines at step 62 whether the CTIS 1 can support compensation by comparing the measured air loss rate with the rate of air loss threshold.

If the CTIS 1 cannot support leakage compensation, a notification is output at step 64 to the HMI 37 to alert the driver to the fact that there is a significant leakage that the CTIS 1 cannot support. If the CTIS 1 can support leakage compensation, support commences at step 66 by activating the compressor 9 to inflate the tyre T to a target pressure, the target pressure being governed by the operating strategies outlined above and in accordance with instantaneous operating conditions for the vehicle VH. A notification to indicate that leakage compensation has been implemented is then output to the HMI 37 at the notification step 64.

It is noted that the step of inflating the tyre T prior to assessing the rate of air loss from the tyre T helps to ensure that the tyre pressure does not become unacceptably low before the assessment completes. However, the time spent inflating the tyre T extends the overall duration of the process 50.

It is noted that the step 62 of determining whether the CTIS 1 can support compensation for a leak may be implemented differently. For example, once the leak rate has been identified at step 60, the leak rate can be compared with a threshold leak rate that the CTIS 1 is capable of supporting over a predetermined time period without reference to the compressor temperature. If the CTIS 1 is capable in principle of providing support, its temperature is then checked enabling the ECU 15 to determine whether the CTIS 1 can run for a minimum CTIS run time without overheating. The minimum CTIS run time may be defined as a fixed time interval, or alternatively it may be defined as a distance of vehicle travel, with the time therefore being calculated from the instantaneous vehicle speed.

FIG. 5 shows a second process 70 for controlling operation of the CTIS 1 to inflate a tyre T to compensate for air loss. As in the process 50 of FIG. 4, the process 70 of FIG. 5 begins with a leakage being detected at step 72 by the TPMS 43. As before, this may entail a leakage alert being generated by the TPMS 43 and passed to the CTIS 1. Alternatively, pressure measurements output by the TPMS 43 may be monitored by the ECU 15 for leakage detection.

Once a leakage has been detected based on TPMS 43 measurements, the CTIS 1 opens the PCV of the tyre T that is suspected of leaking to take a measurement at step 74 of the tyre pressure. One or more further tyre pressure measurements are taken at spaced intervals over an extended time period, to provide sufficient measurement data not only to confirm the presence of a leak, but to assess the rate of air loss with accuracy also. Therefore, the process 70 of FIG. 5 skips the inflation step 58 of the process shown in FIG. 4 following the initial CTIS 1 pressure measurement step 54. Instead, in the process shown in FIG. 5 a full assessment of the leakage is performed immediately by the CTIS 1 on detection of a leakage by the TPMS 43. This assessment results in a determination at step 76 of whether there is a leakage and, if necessary, a calculation at step 78 of whether leakage compensation can be supported.

If the CTIS 1 finds no leakage at step 76, the process 70 returns to the initial step 72 of awaiting detection of a leak by the TPMS 43. As stated above, if the CTIS system determines there is not a pressure leak a TPMS error may be identified and corresponding action taken.

If the CTIS 1 detects that the tyre T is leaking, the pressure measurement data gathered by the CTIS 1 is analysed to determine the rate of air loss from the tyre T. As before, the temperature of the compressor 9 is also measured, and from this the rate of air loss threshold is calculated. The ECU 15 then compares the air loss rate with the rate of air loss threshold to determine at step 78 whether the compressor 9 is able to support leakage compensation without overheating.

As with the process 50 of FIG. 4, in the process 70 of FIG. 5 the step 78 of determining whether the CTIS 1 can support compensation for a leak may be implemented differently. For example, once the leak rate has been identified at step 76, the leak rate can be compared with a threshold leak rate that the CTIS 1 is capable of supporting over a predetermined time period without reference to the compressor temperature. If the CTIS 1 is capable in principle of providing support, its temperature is then checked enabling the ECU 15 to determine whether the CTIS 1 can run for a minimum CTIS run time without overheating. The minimum CTIS run time may be defined as a fixed time interval, or alternatively it may be defined as a distance of vehicle travel, with the time therefore being calculated from the instantaneous vehicle speed.

If the CTIS 1 cannot support leakage compensation, a notification is output at step 80 to the HMI 37 to alert the driver to the fact that there is a significant leakage that the CTIS 1 cannot support. If the CTIS 1 can support leakage compensation, support commences at step 82 by activating the compressor 9 to inflate the tyre T to a target pressure, the target pressure being governed by the operating strategies mentioned above. A notification to indicate that leakage compensation has been implemented is then output to the HMI 37 at the notification step 80.

The process 70 of FIG. 5 provides an assessment of a leakage more quickly than the first process 50 shown in FIG. 4, meaning that leakage compensation can be initiated earlier. This also enables earlier notification of a problem to the driver. However, as the tyre T is not inflated prior to assessing the air loss rate in the process of FIG. 5, there is a risk that the assessment procedure could cause the tyre pressure to drop unacceptably to a point where compensation is no longer viable. These considerations must be balanced when considering which of the two approaches to implement.

It will be appreciated by a person skilled in the art that the invention could be modified to take many alternative forms to that described herein, without departing from the scope of the appended claims.

1. A central tire inflation system of a vehicle for supplying compressed air to a tire of the vehicle to compensate for air loss from the tire, the central tire inflation system comprising:
means for determining a rate of air loss from the tire;
a sensor arranged to measure a temperature of a compressor of the central tire inflation system; and
an electronic control unit configured to:
compare the rate of air loss with a rate of air loss threshold;
determine, based on the compressor temperature and the comparison of the rate of air loss with the rate of air loss threshold, whether to use the central tire inflation system to compensate for the air loss; and
control the central tire inflation system to supply compressed air to the tire to compensate for the air loss if it is determined to use the central tire inflation system to compensate for the air loss.

2. A central tire inflation system as claimed in claim 1, wherein the electronic control unit comprises:
an electronic processor having an electrical input for receiving a signal indicative of the temperature of said compressor; and
an electronic memory device electrically coupled to the electronic processor and having instructions stored therein,
wherein said electronic control unit configured to: compare the rate of air loss with a rate of air loss threshold; determine, based on the compressor temperature and the comparison of the rate of air loss with the rate of air loss threshold, whether to use the central tire inflation system to compensate for the air loss; and control the central tire inflation system to supply compressed air to the tire to compensate for the air loss if it is determined to use the central tire inflation system to compensate for the air loss comprises the electronic processor being configured to access the memory device and execute the instructions stored therein such that it is operable to determine, based on the compressor temperature and the comparison of the rate of air loss with the rate of air loss threshold, whether to use the central tire inflation system to compensate for the air loss; and control the central tire inflation system to supply compressed air to the tire to compensate for the air loss.

3. A central tire inflation system as claimed in claim 1, wherein the electronic control unit is configured to calculate the rate of air loss threshold with reference to a pumping capacity of the compressor of the central tire inflation system.

4. A central tire inflation system as claimed in claim 1, wherein the electronic control unit is configured to determine based on the compressor temperature whether the compressor can operate for a defined period without exceeding a temperature threshold, and further configured to determine that the central tire inflation system cannot support compensation for the air loss if the compressor temperature will exceed the temperature threshold in the defined period.

5. A central tire inflation system as claimed in claim 1, wherein the electronic control unit is configured to calculate the rate of air loss threshold with reference to the compressor temperature.

6. A central tire inflation system as claimed in claim 1, comprising an input arranged to receive a signal indicative of air pressure within the tire, wherein the electronic control unit is configured to monitor the signal indicative of air pressure within the tire to detect a leak from the tire prior to determining a rate of air loss from the tire.

7. A central tire inflation system as claimed in claim 6, wherein the signal indicative of air pressure within the tire is received from a tire pressure monitoring system installed on the vehicle.

8. A central tire inflation system as claimed in claim 1, comprising an input arranged to receive from a tire pressure monitoring system installed on the vehicle a signal indicative of a leak from the tire.

9. A central tire inflation system as claimed in claim 1, wherein the means for determining a rate of air loss from the tire comprises:
a valve that is operable by the electronic control unit to open or close communication between the tire and a supply line through which compressed air is supplied to the tire; and
a pressure sensor configured to measure air pressure in the supply line;
wherein the electronic control unit is arranged to:
open the valve;
while the valve is open, take a first measurement of air pressure in the supply line;
close the valve;
re-open the valve after a time interval has elapsed;
while the valve is open, take a second measurement of air pressure in the supply line; and
compare the first and second measurements of air pressure to determine the rate of air loss.

10. A central tire inflation system as claimed in claim 1, wherein the electronic control unit is configured to control the central tire inflation system to inflate the tire at least substantially to a target tire pressure.

11. A central tire inflation system as claimed in claim 1, wherein the electronic control unit is configured to generate an output signal to inform a user of the vehicle that the central tire inflation system will not attempt to inflate the tire if the central tire inflation system cannot support compensation for the air loss.

12. A central tire inflation system as claimed in claim 1, wherein the electronic control unit is configured to determine a vehicle speed limit based on the rate of air loss from the tire.

13. A central tire inflation system as claimed in claim 1, wherein compensating for the air loss comprises controlling the central tire inflation system to supply compressed air to the tire at a rate which is substantially equal to or greater than the determined rate of air loss from the tire

14. A method of controlling operation of a central tire inflation system of a vehicle to supply compressed air to a tire of the vehicle to compensate for air loss from the tire, said method comprising:
determining a rate of air loss from the tire;
measuring a temperature of a compressor of the central tire inflation system;
comparing the rate of air loss with a rate of air loss threshold;
determining, based on the compressor temperature and the comparison of the rate of air loss with the rate of air loss threshold, whether to use the central tire inflation system to compensate for the air loss; and
using the central tire inflation system to supply compressed air to the tire to compensate for the air loss if it is determined to use the central tire inflation system to compensate for the air loss.

15. A method as claimed in claim 14, comprising calculating the rate of air loss threshold with reference to a pumping capacity of the compressor of the central tire inflation system.

16. A method as claimed in claim 14, comprising determining based on the compressor temperature whether the compressor can operate for a defined period without exceeding a temperature threshold, and determining that the central tire inflation system cannot support compensation for the air loss if the compressor temperature will exceed the temperature threshold in the defined period.

17. A method as claimed in claim 14, comprising calculating the rate of air loss threshold with reference to the compressor temperature.

18. A method as claimed in claim 14, comprising, prior to determining a rate of air loss from the tire, detecting a leak from the tire.

19-26. (canceled)

27. An electronic control unit for controlling a central tire inflation system, the electronic control unit being configured to implement a method as claimed in claim 14.

28. A vehicle comprising a central tire inflation system as claimed in claim 1.

29-30. (canceled)
